(19) United States
(12) Patent Application Publication
(10) Pub. No.: US 2003/0011845 A1
(43) Pub. Date: Jan. 16, 2003

(54) Wavelength multiplexing optical fibre transmission device

(76) Inventors: Gilles Billet, Voiron (FR); Christian Sillans, La Frette (FR)

Correspondence Address: Oliff & Berridge, PO Box 19928, Alexandria, VA, 22320, US

(21) Appl. No.: 10/204,042

(22) PCT Filed: Apr. 4, 2001
(86) PCT No.: PCT/FR01/01016

(30) Foreign Application Priority Data
Apr. 11, 2000 (FR) 00/04649

(51) Int. Cl. H04J 14/02

(52) U.S. Cl. 359/133; 359/124

(57) ABSTRACT

The invention concerns a wavelength multiplexing optical fiber transmission device comprising multiplexing means with optical combiner (16) consisting of a series of n optical couplers CO1, CO2, CO7 with asymmetric cascade distribution over several stages A, B, C for combining the optical signals received from the optical transmitters (14) of different wavelengths (λ1 to λ8). The last coupler CO7 routes the multiplexed optical signals to a main transmission line (18) and a standby transmission line (20). The coupling ratio of the various couplers is adjusted at the channels to compensate spectral gain variation of the optical amplifier (26), which is arranged on the receiver side before the optical demultiplexer (28). The invention is applicable to metropolitan area telecommunication networks.

### BACKGROUND OF THE INVENTION

The invention concerns a wavelength multiplexing optical fibre transmission device, notably for metropolitan area telecommunication networks, comprising:

optical transmitters linked with electronic transmission devices in order to transmit optical signals of wavelengths matching preset channels,

means for multiplexing the optical signals transmitted by the optical transmitters,

means for concentrating the wavelength multiplexed optical signals to an optical fibre transmission network extending over a preset distance,

at least one optical amplifier, which reproduces a level of optical signal before sorting the wavelengths through optical demultiplexing means,

and optical receivers receiving the optical signals multiplexed and selected by the demultiplexing means.

### STATE OF THE ART

The wavelength multiplexing DWDM transmission technique combines the multiplexing effect with the optical amplification to provide long distance and high throughput transmission networks.

In the DWDM systems known, an optical amplifier is generally implanted at the head of the network, just after the multiplexer and before the optical fibre transmission network. Spectral control of the gain of the optical amplifier is performed using equaliser filters or using selective control of the saturation phenomena. Another known solution consists in using attenuators after the demodulator in order to attenuate the channels with the highest gain.

These known devices are expensive and limit the throughput of the amplifier as well as its transmission capacity.

### OBJECT OF THE INVENTION

The object of the invention consists in providing a wavelength multiplexing optical fibre transmission device, with a cheap and simplified structure for metropolitan area communication networks, and benefiting from a redundancy for transmission of the signals.

The device according to the invention is characterised in that:

the multiplexing means comprise an optical combiner consisting of a series of n optical couplers with asymmetric cascade distribution over several stages for combining the optical signals received from the optical transmitters of different wavelengths, whereas the last coupler is laid out to route the multiplexed optical signals to a main transmission line and a standby transmission line,

the coupling ratio of the different optical couplers is adjusted at the channels to compensate the spectral gain variation of the optical amplifier.

According to a characteristic of the invention, the optical amplifier is arranged on the receiver side before the optical demultiplexer.

According to a characteristic of the invention, the main transmission line and the standby transmission line are connected to a microcontroller-operated optical switch to provide redundancy by switching automatically to the standby transmission line in case of incident on the main transmission line, whereas the output of the optical switch is linked by an optical fibre to the input of the amplifier.

According to a preferred embodiment of the invention,

each coupler of the first stage receives two optical signals of different wavelengths from a pair of optical transmitters,

each coupler of the second stage receives the output optical signals from a pair of couplers of the first stage,

both outputs of the last coupler of the stage are connected with said main and standby transmission lines.

The optical transmitters consist, for exemplification purposes, of wavelength stabilised laser transmitters. The optical receivers of wavelength demultiplexed signals are composed of photodiodes, each associated with an automatic gain control circuit.

The coupling ratio of the different optical couplers of the optical combiner (16) is obtained either by polishing-assembly, or by fusion-stretching, or by an integrated optics.

### BRIEF DESCRIPTION OF THE DRAWINGS

Other advantages and characteristics will appear more clearly from the following description of an embodiment of the invention given for exemplification purposes and represented on the appended drawings wherein:

FIG. 1 is a flow chart of the optical fibre and multiplexing transmission device according to the invention;

FIG. 2 represents a schematic view of the optical combiner with asymmetric couplers;

FIG. 3 shows a table with the different combinations of couplers for the compensation of the spectral gain of the amplifier;

FIG. 4 shows the gain curve of the optical amplifier before compensation.

### DESCRIPTION OF A PREFERRED EMBODIMENT

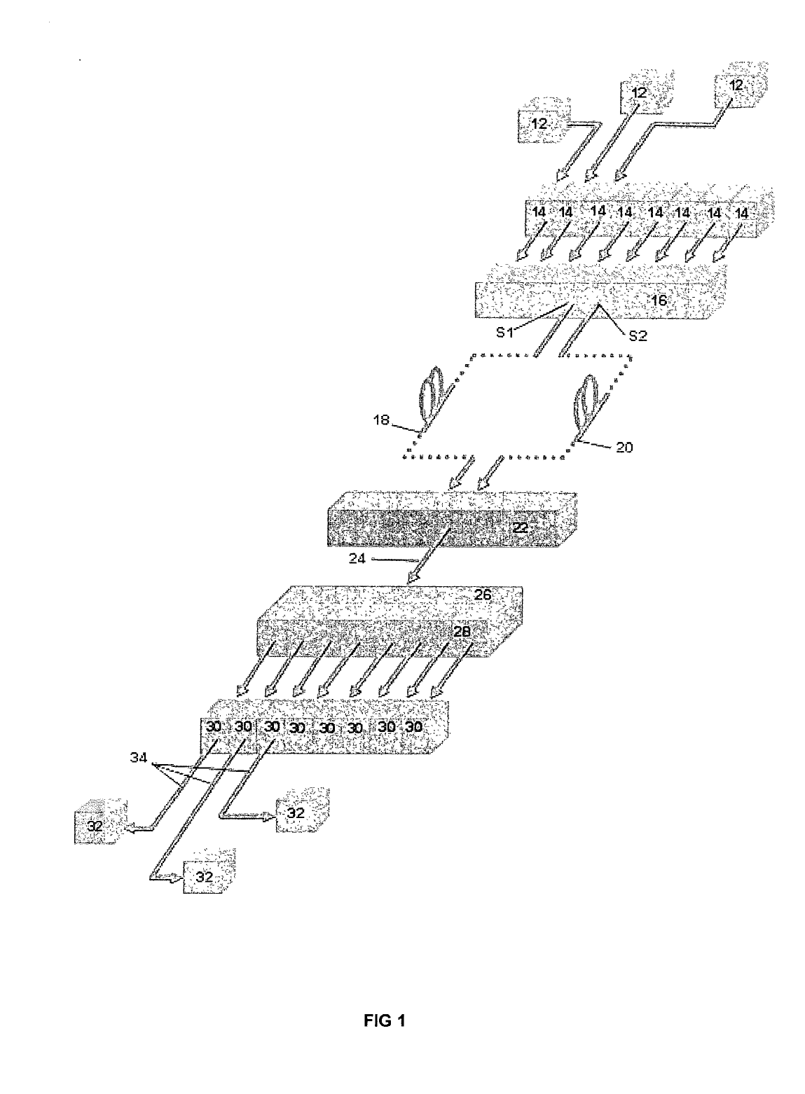

With reference to FIG. 1, a wavelength multiplexing optical fibre transmission device 10 is used for the transmission of telecommunication signals in metropolitan area communication networks. This is a DWDM system with several wavelengths λ1 to λ8 (eight for exemplification purposes), spaced by 200 GHz, and enabling to carry signals whereof the bandwidth is greater than 2 GHz over a given distance, for example 50 kilometers.

During transmission, the electronic transmission devices 12 are connected to a plurality of optical transmitters 14 fitted with wavelength stabilised laser transmitters.

An optical combiner 16 receives the optical signals of wavelengths λ1 to λ8 transmitted by the different laser transmitters, and comprises two outputs S1 and S2. The output S1 concentrates the signals from all the optical transmitters 14 over an optical fibre of a main transmission line 18 with a distance of several kilometers.

The other output S2 of the optical combiner 16 provides a copy of the same signal over an optical fibre of a standby transmission line 20.

Upon reception, an optical switch 22 is driven by a microcontroller to select the line 18 or 20 used for transmission. The switch 22 provides the redundancy of the transmission device 10 while switching automatically to the standby line 20 in case of incident on the main line 18. The output of the optical switch 22 is connected by an optical fibre 24 to an optical amplifier 26, which reproduces a preset level of optical signal before sorting the wavelengths λ1 to λ8 through an optical demultiplexer 28. Said demultiplexer selects the demultiplexed optical signals of wavelengths λ1 to λ8 supplied to optical receivers 30. It may consist either of a simple demultiplexer or, in a known fashion, of an appropriate combination of demultiplexers and of one or several interleavers.

The optical receiver 30 for each wavelength λ1 to λ8, comprises a photodiode associated with an automatic gain control circuit. Electronic reception devices 32 are connected electrically by conductors 34 to the different optical receivers.

The amplifier 26 with integrated optics is arranged on the receiver side just before the optical demultiplexer 28.

For exemplification purposes, the eight wavelengths selected according to the channels of the grid UIT and spaced by 200 GHz, are as follows:

λ1=1531.90 nm (channel 57)

λ2=1533.47 nm (channel 55)

λ3=1535.04 nm (channel 53)

λ4=1536.61 nm (channel 51)

λ5=1538.19 nm (channel 49)

λ6=1539.77 nm (channel 47)

λ7=1541.35 nm (channel 45)

λ8=1542.94 nm (channel 43)

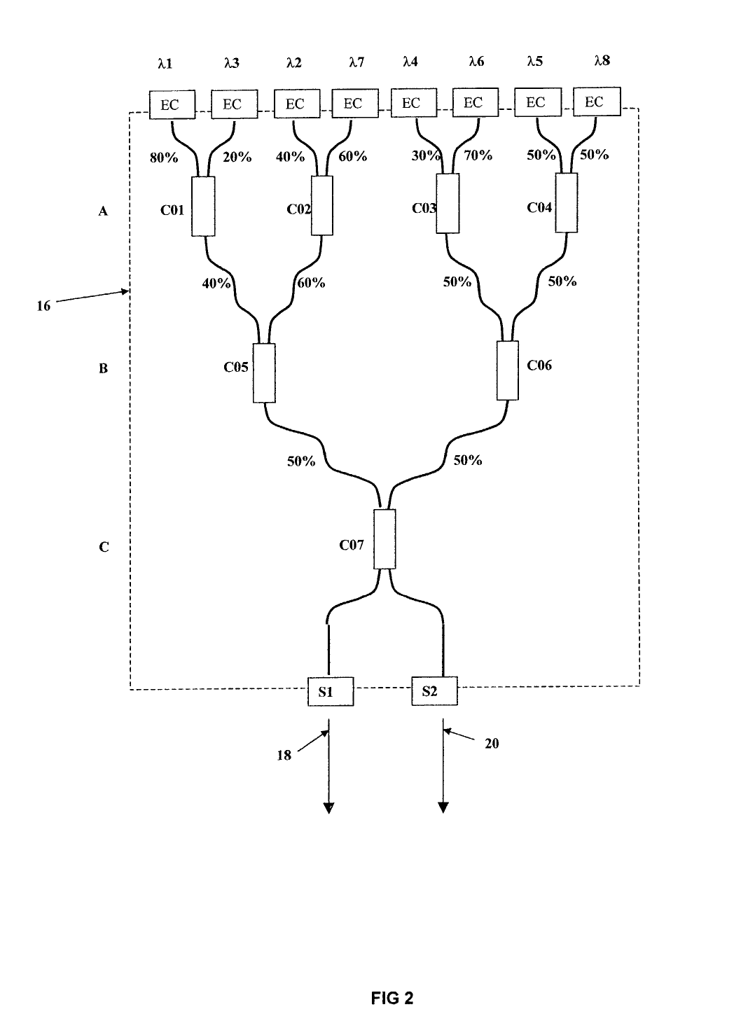

On FIG. 2, the optical combiner 16 consists of a series of n optical couplers C01, CO2, CO3, CO4, CO5, CO6, CO7, with asymmetric cascade distribution according to three stages. Such a combiner 16 enables to combine the optical signals received from the optical transmitters 14 of different wavelengths λ1 to λ8, and to route them to the main transmission line 18, and the standby transmission line 20. It replaces the conventional multiplexer of the previous art.

The technology of the optical couplers CO1 to CO7 can be provided in different manners, already known as such:

Either by polishing-assembly consisting in sealing two optical fibres in a glass block, in polishing while positioning the core at the surface, and in assembling both blocks for coupling the light between the cores of the fibres. The coupling ratio can be adjusted by varying the angle between both blocks;

Or by fusion-stretching, consisting in heating and in stretching a fibre to reduce the diameter of its core and of its sheath. The coupler is formed by two adjacent stretched fibres, making up an input adapter, a coupling region and an output adapter. The light entering one of the input fibres is shared between two output fibres;

Or in integrated optics, by adjustment of dimensions of the waveguides.

The coupling ratio of each optical coupler C01 to CO7 depends on the length of interaction of the coupled fibres and on the bias condition of the incident light. It enables unequal distribution of the power between the inputs and the outputs.

The coupling ratio of the couplers CO1 to CO6 of the first stage and of the second stage is adjusted with respect to the spectral gain of the integrated optic amplifier 26. At the first stage, the first coupler CO1 receives the optical signals of wavelengths λ1 and λ3 with a coupling ratio 20/80. The second coupler CO2 receives the optical signals of wavelengths λ2 and λ7 with a coupling ratio 40/60. The third coupler CO3 receives the optical signals of wavelengths λ4 and λ6 with a coupling ratio 30/70. The fourth coupler CO4 receives the optical signals of wavelengths λ5 and λ8 with a coupling ratio 50/50.

At the second stage, the fifth coupler CO5 receives the output signals of wavelengths λ1, λ3, λ2 and λ7 from first and second couplers CO1 and CO2 with a coupling ratio 40/60. The sixth coupler CO6 receives the output signals of wavelengths λ4, λ6, λ5 and λ8 from the third and fourth couplers CO3 and CO4 with a coupling ratio 50/50.

The seventh coupler CO7 of the third stage receives the output signals of all the wavelengths of the fifth coupler CO5 and of the sixth coupler CO6 with a coupling ratio 50/50. It provides the redundancy of the transmission lines 18 and 20.

A single output is used for the couplers C01-CO6 of both first stages, whereas the coupler CO7 of the third stage makes use of both outputs to supply the main transmission line 18, and the standby transmission line 20.

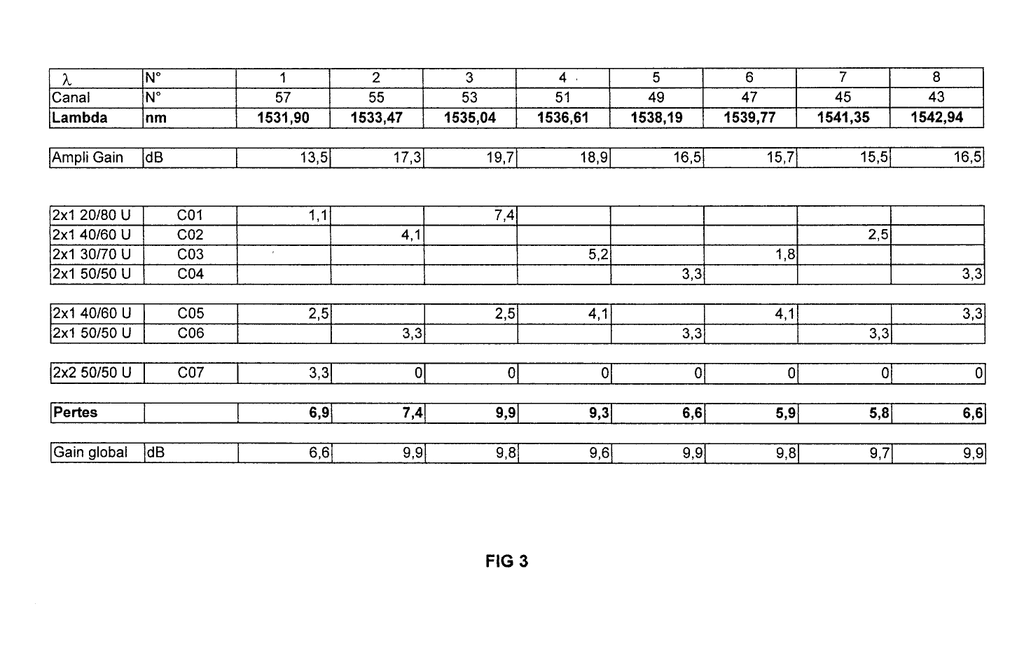

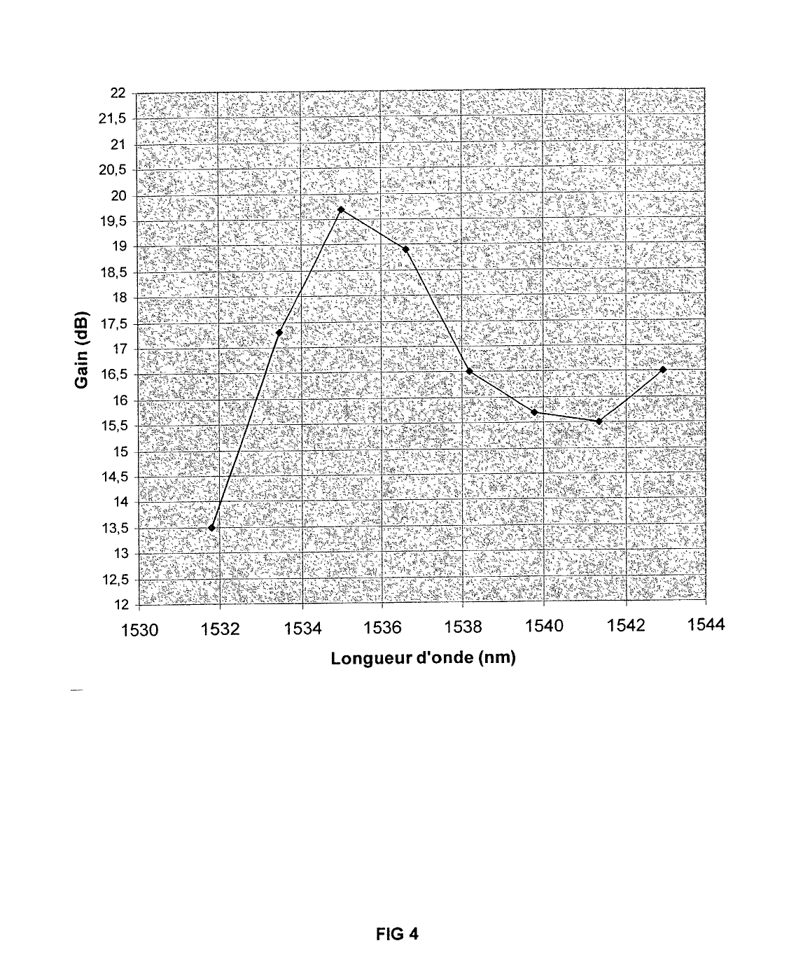

With reference to FIGS. 3 and 4, the asymmetric coupling of the couplers CO1 to CO7 enables to compensate the gain variation of the optical amplifier 26 in relation to the different channels. The transmission losses in the different couplers CO1 to CO7 enable to obtain at the output of the optical amplifier 26 a global gain which is substantially constant. Such a spectral control of the gain is performed without equaliser filters nor attenuators allocated to the high gain channels.

The presence, upon the transmission of such an optical combiner 16 with asymmetric couplers CO1-CO7, enables simultaneously to multiplex the wavelengths I1 to I8 from the optical transmitters 14, and to equalise the gain of the optical amplifier 26 on the receiving side. The number of outputs of the optical combiner 16 is variable in relation to the distribution of the couplers.

1. A wavelength multiplexing optical fibre transmission device, notably for metropolitan area telecommunication networks, comprising:
optical transmitters (14) connected with electronic transmission devices (12) to transmit optical signals of wavelengths (λ1 to λ8) matching preset channels,
means for multiplexing optical signals transmitted by the optical transmitters (14),
means for concentrating the wavelength multiplexed optical signals to an optical fibre transmission network extending over a preset distance,
at least one optical amplifier (26), which reproduces a level of optical signal before sorting the wavelengths (λ1 to λ8) through optical demultiplexing means (28),
and optical receivers (30) receiving the optical signals multiplexed and selected by the demultiplexing means (28),
characterised in that:
the multiplexing means comprise an optical combiner (16) consisting of a series of n optical couplers (CO1, CO2, . . . CO7) with asymmetric cascade distribution over several stages (A, B, C . . . ) for combining the optical signals received from the optical transmitters (14) of different wavelengths (λ1 to λ8), whereas the last coupler (CO7) is arranged to route the multiplexed optical signals to a main transmission line (18) and a standby transmission line (20),
the coupling ratio of the different optical couplers is adjusted at the channels to compensate the spectral gain variation of the optical amplifier (26).

2. An optical fibre transmission device according to claim 1, characterised in that the optical amplifier (26) is arranged on the receiver side before the optical demultiplexing means (28).

3. An optical fibre transmission device according to claim 2, characterised in that the main transmission line (18) and the standby transmission line (20) are connected to an optical switch (22) driven by a microcontroller for redundancy by switching automatically to the standby transmission line (20) in case of incident on the main transmission line (18), whereas the output of the optical switch (22) is connected by an optical fibre (24) to the input of the amplifier (26).

4. An optical fibre transmission device according to one of the previous claims, characterised in that:
each coupler (C01, CO2, CO3, CO4) of the first stage (A) receives two optical signals of different wavelengths from a pair of optical transmitters (14),
each coupler (CO5, CO6) of the second stage (B) receives the output optical signals from a pair of couplers (C01, CO2; CO3, CO4) of the first stage (A),
both outputs of the last coupler (CO7) of the stage (C) are connected with said main (18) and standby (20) transmission lines.

5. An optical fibre transmission device according to one of the previous claims, characterised in that the optical transmitters (14) are formed by wavelength stabilised laser transmitters.

6. An optical fibre transmission device according to one of the previous claims, characterised in that the optical receivers (30) of the wavelength demultiplexed signals are formed by photodiodes each associated with an automatic gain control circuit.

7. An optical fibre transmission device according to one of the previous claims, characterised in that the coupling ratio of the different optical couplers (CO1-CO7) of the optical combiner (16) is obtained either by polishing-assembly or by fusion-stretching or by integrated optics.
